(19) United States
(12) Patent Application Publication
(10) Pub. No.: US 2011/0018816 A1
(43) Pub. Date: Jan. 27, 2011

(54) MODULAR TOUCH CONTROL ASSEMBLY AND ELECTRONIC DEVICE HAVING THE SAME

(76) Inventors: Bo-Wen LIU, Taipei County (TW); Ho-Kuo Chueh, Hsichih (TW)

Correspondence Address: Muncy, Geissler, Olds & Lowe, PLLC, 4000 Legato Road, Suite 310, FAIRFAX, VA, 22033, US

(21) Appl. No.: 12/647,764

(22) Filed: Dec. 28, 2009

(30) Foreign Application Priority Data
Jul. 22, 2009 (TW) 98124773

(51) Int. Cl. G06F 3/041

(52) U.S. Cl. 345/173

(57) ABSTRACT

A modular touch control assembly is applicable to an electronic device for generating contact operating signals and a press operating signals. The modular touch control assembly includes a substrate, a touchpad, and at least one elastic member. The touchpad is disposed on the substrate, and is provided to be contacted to generate the contact operating signals. The touchpad is also provided to be pressed and tilted, and detectors such as switches or displacement detectors monitor the touchpad. As the touchpad is tilted, a corresponding press operating signal is generated by the detectors according to the direction that the touchpad is tilted. The elastic member is disposed between the touchpad and the substrate, to be pressed by the tilted touchpad, to generating an elastic force to reset the touchpad to the original position.

### CROSS-REFERENCES TO RELATED APPLICATIONS

This non-provisional application claims priority under 35 U.S.C. §119(a) on Patent Application No. 98124773 filed in Taiwan, R.O.C. on Jul. 22, 2009, the entire contents of which are hereby incorporated by reference.

### BACKGROUND OF THE INVENTION

1. Technical Field

The present invention relates to a touchpad, and more particularly to a modular touch control assembly, which is capable of being touched to generating a contact operating signal and capable of being pressed to be tilted, to generate a press operating signal.

2. Related Art

Currently, since the graphic user interface (GUI) is widely used in computer operating systems and applications, a cursor control device such as a mouse or a touchpad includes become an important computer peripheral device for operating a computer.

When a user processes text data or browses a webpage, the text usually exceeds displaying area of the window. The user has to move a cursor to click a scroll bar at a side edge of the window, in order to scroll down a displayed data in the window to change the displayed part of the text data for being displayed. The operation of clicking the scroll bar to scroll up/down the displayed data in the window includes a low efficiency, so that a scroll mouse with a scroll wheel is proposed in the prior art, in which a scroll wheel is disposed on the mouse. The user rotates the scroll wheel back- and forth to generate a scroll-up signal or scroll-down signal, so as to scroll the displayed data in the window rapidly.

Almost all the current laptop computers are equipped with a touchpad as a typical cursor control device, and these laptop computers are not equipped with a scroll wheel. The touchpad is used for detection of a change of a track made by a contact point on the touch control surface, and then generates a corresponding contact operating signal to move the cursor. The touchpad also detects a change of the time when the contact point is contacted within a short time period, for example touchpad detects whether the contact point is touched swiftly and released, and then generates a corresponding press operating signal. The touchpad lacks a function of scrolling the displayed data in the window rapidly. Therefore the user has to click a scroll bar to scroll the displayed data in the window.

In order to solve the above problem, additional program codes are currently added in a driver or firmware of a touchpad, such that an edge area of the touchpad is set as an area for scrolling the window. That is, when the user touches an edge of the touchpad and performs a motion of slipping up and down, the touchpad generates an operation similar to dragging the scroll bar at a side edge of the window. However, mis-operation occurs easily. For example, when the user actually needs to move down the cursor, the user may scroll down the displayed data in the window by mistake as the point the user touched at this time is close to the side edge of the touchpad.

The other solutions are to modify the physical structure of the touchpad. For example, Taiwan (R.O.C) Utility Model No. M343208 discloses a touch control apparatus and information processing apparatus having the same. The touch control apparatus includes two touch panels. One of the touch panels is disposed above a first switch unit while the other one is disposed above a second switch unit. The two touch panel can be pressed to move downward, therefore the first switch unit and the second switch unit are triggered correspondingly, so as to scroll up or scroll down a display range of the window.

In No. M343208, two touch panels are equipped within the touch control device at the same time, resulting in a higher cost. Furthermore, an operation of taking turns to operate two touch panels does not conform to the regular behavior of a common user operating the touchpad.

### SUMMARY

The touchpad in the prior art lacks a physical structure design of scrolling displayed data in a window rapidly, so that a software is require to provide an additional function of scrolling the window. The window scrolling function realized through software does not conform to the regular behavior of a user when operating a push button or a mouse scroll wheel. A touchpad with modified physical structure includes a complicated structure, and still does not conform to the operation regular behavior of a user when operating a push button or a scroll wheel of a mouse.

Accordingly, the present invention provides a modular touch control assembly, conforming to the regular behavior of a user when operating a push button. The modular touch control assembly is a single module, such that procedures for installing the modular touch control assembly on an electronic element are simplified.

The present invention provides a modular touch control assembly for generating a contact operating signal and two press operating signals. The modular touch control assembly includes a substrate, a touchpad, at least one elastic member, and two switches. The touchpad is pivotally disposed on the substrate for being tilted along a rotation axis after being pressed at an original position to change an included angle between the touchpad and the substrate. The touchpad includes a touch control surface and a bottom surface. The touch control surface is provided for being contacted to generate a contact operating signal. The bottom surface faces the substrate. The elastic member is disposed between the bottom surface of the touchpad and the substrate and used for being compressed and deformed by the tilted touchpad to generate an elastic force to reset the touchpad to the original position. The two switches are disposed on the substrate and located at two sides of the rotation axis. Each switch is for being pressed after the touchpad is tilted, so as to generate one of the two corresponding press operating signals.

In addition to generating a contact operating signal, the touchpad is further tilted upon being pressed in order to generate a press operating signal corresponding to the inclining direction. Each press operating signal corresponds to one inclining direction. Thus when the present invention is applied to scrolling a window, a more intuitive operation is provided.

In one or a plurality of embodiments of the present invention, the touch control surface of the touchpad includes a touch control area and a pressed area. The touch control area is provided for being contacted to generate a contact operating signal. The pressed area is equipped without touch control function, and surrounds the touch control surface. Therefore, when a user touches the pressed area to tilt the touchpad, the touchpad does not generate a contact operating signal, thereby avoiding interference between the press operating signal and the contact operating signal.

In one or a plurality of embodiments, the present invention provides an electronic device having a modular touch control assembly, which includes a body and the above-mentioned modular touch control assembly. The modular touch control assembly is disposed in the body, such that the touchpad is exposed through an opening of the body for being operated by the user.

The present invention is further directed to a modular touch control assembly, which includes a simple structure and is easily assembled.

In one or a plurality of embodiments, the present invention provides a modular touch control assembly for generating a contact operating signal and a plurality of press operating signals. The modular touch control assembly includes a substrate, a touchpad, at least one elastic member, and a plurality of switches. The touchpad is disposed on the substrate and is spaced from the substrate. The touchpad is provided for being tilted when the touchpad is pressed at an original position. The touchpad includes a touch control surface and a bottom surface. The touch control surface is provided for being contacted to generate a contact operating signal. The bottom surface faces the substrate. The elastic member is used for the purpose of generating an elastic force to reset the touchpad to the original position when the touchpad is tilted. The switches are disposed on the substrate and used for being pressed by the tilted touchpad respectively, in order to generate corresponding press operating signals.

The above embodiment of the present invention simplifies the component structure and the connecting relations. Thus, the present invention provides a modular touch control assembly, which includes a simple structure and is easily assembled.

In one or a plurality of embodiments of the present invention, the touch control surface of the touchpad includes a touch control area and a pressed area. The touch control area is provided for being contacted to generate a contact operating signal. The pressed area is equipped without touch control function and surrounds the touch control surface. Therefore, when a user presses the pressed area to tilt the touchpad, the touchpad does not generate a contact operating signal, so as to avoid the interference between the press operating signal and the contact operating signal.

In one or a plurality of embodiments, the present invention provides an electronic device having a modular touch control assembly, which includes a body and the above-mentioned modular touch control assembly. The modular touch control assembly is disposed in the body, such that the touchpad is exposed through an opening of the body for being operated by the user.

The present invention is further directed to a modular touch control assembly, which provides a press function having push-button characteristics, and conforms to visual and operational regular behaviors of the user.

In view of the above objective, in one or a plurality of embodiments, the present invention provides a modular touch control assembly for generating a contact operating signal and a plurality of press operating signals. The modular touch control assembly includes a substrate, a touchpad, a plurality of elastic blocks, and a plurality of switches. The touchpad is disposed on the substrate and is spaced from the substrate. The touchpad includes a touch control surface and a bottom surface. The touch control surface includes a touch control area and a pressed area surrounding the touch control area. The touch control area is provided for being contacted to generate a contact operating signal. The pressed area is equipped without touch control function. The bottom surface faces the substrate. The elastic blocks are disposed on the bottom surface of the touchpad in pairs. A rotation axis runs through each pair of elastic blocks. Each elastic block is disposed corresponding to a boundary between the touch control area and the pressed area. Each elastic block is deformed when the touchpad is tilted, in order to generate an elastic force for resetting the touchpad to an original position. The switches are disposed on the substrate and are pressed by the tilted touchpad respectively, in order to generate corresponding press operating signals.

In one or a plurality of embodiments, the present invention provides an electronic device having a modular touch control assembly, which includes a body and the above modular touch control assembly. The modular touch control assembly is disposed in the body, such that the touchpad is exposed through an opening of the body for being operated by the user.

The present invention is further directed to a modular touch control assembly, which simplifies a combination of the components of the modular touch control assembly, provides a press function having push-button characteristics, and conforms to visual and operational regular behaviors of a user.

In one or a plurality of embodiments, the present invention provides a modular touch control assembly for generating a contact operating signal and a plurality of press operating signals. The modular touch control assembly includes a touchpad and a plurality of elastic members. The touchpad includes a touch control surface and a bottom surface. The touch control surface includes a touch control area and a pressed area surrounding the touch control area. The touch control area is provided for being contacted to generate a contact operating signal. The pressed area is divided into a plurality of sections. Each section is provided for being pressed to generate a corresponding press operating signal. The elastic members are disposed on the bottom surface of the touchpad. The touchpad may be tilted upon being pressed, such that the elastic members generate an elastic force for resetting the touchpad.

The abovementioned modular touch control assembly further omits a detecting device for the detection of a tilting status of the touchpad, so that the combination of the components of the modular touch control assembly is further simplified.

In one or a plurality of embodiments, the present invention provides an electronic device having a modular touch control assembly, which includes a body and the above modular touch control assembly. The modular touch control assembly is disposed in the body, such that the touchpad is exposed through an opening of the body for being operated by the user.

The present invention is further directed to an electronic device having a modular touch control assembly, which simplifies a the combination of the components of the modular touch control assembly, further decreases an occupied space and a thickness of the modular touch control assembly therefore, a thickness of the electronic device having the modular touch control assembly is decreased.

In one or a plurality of embodiments the present invention provides an electronic device having a modular touch control assembly, for generating a contact operating signal and a plurality of press operating signals. The electronic device having a modular touch control assembly includes a body, a substrate, a touchpad, at least one elastic member, and a plurality of displacement detectors. The body includes an opening and the substrate is disposed in the body. The touchpad is disposed on the substrate and is spaced from the substrate. The touchpad may be tilted upon being pressed. The touchpad includes a touch control surface and a bottom surface. The touch control surface is provided for being contacted to generate a contact operating signal. The bottom surface faces the substrate. The elastic member is disposed between the substrate and the bottom surface of the touchpad and is deformed when the touchpad is tilted, to generate an elastic force for resetting the touchpad to an original position. The displacement detectors are disposed in the body and located at the edges of the opening, and used for the detection of whether the displacement occurs at the edges of the touchpad or not. Corresponding press operating signals are generated when it is detected that the displacement occurs at the edges of the touchpad.

The advantage of the present invention is that the modular touch control assembly provided in the present invention includes an operation mode conforming to a regular behavior of a common user, and corresponding press operating signals are directly generated according to inclining directions of the touchpad. The user determines an operation function corresponding to a press operating signal directly through the tilting direction of the touchpad. The present invention therefore realizes an intuitive and simple operation mode. In addition, in one or a plurality of embodiments the present invention provides a modular touch control assembly with a simplified combination of components, which thus is conveniently manufactured and easily assembled.

### BRIEF DESCRIPTION OF THE DRAWINGS

FIG. 1 is an exploded view of a first embodiment of the present invention;

FIG. 2 is a perspective view of the first embodiment of the present invention;

FIG. 3 is a cross-sectional view of the first embodiment of the present invention;

FIGS. 4 and 5 are cross-sectional views of the first embodiment of the present invention, showing a frame, a touchpad, and an elastic member to illustrate how the elastic member generates elastic force;

FIGS. 6 and 7 are cross-sectional views of the first embodiment of the present invention to illustrate the operation that switches are pressed;

FIG. 8 shows an electronic device in which an embodiment of the present invention is applied;

FIG. 9 is an exploded view of a second embodiment of the present invention;

FIG. 10 is a cross-sectional view of the second embodiment of the present invention;

FIG. 11 is a cross-sectional view of a third embodiment of the present invention;

FIG. 12 is a perspective view of a fourth embodiment of the present invention;

FIG. 13 is an exploded view of the fourth embodiment of the present invention;

FIG. 14 is a perspective view of the fourth embodiment of the present invention;

FIG. 15 is a top view of the fourth embodiment of the present invention; and

FIGS. 16 and 17 are cross-sectional views of a fifth embodiment of the present invention.

### DETAILED DESCRIPTION

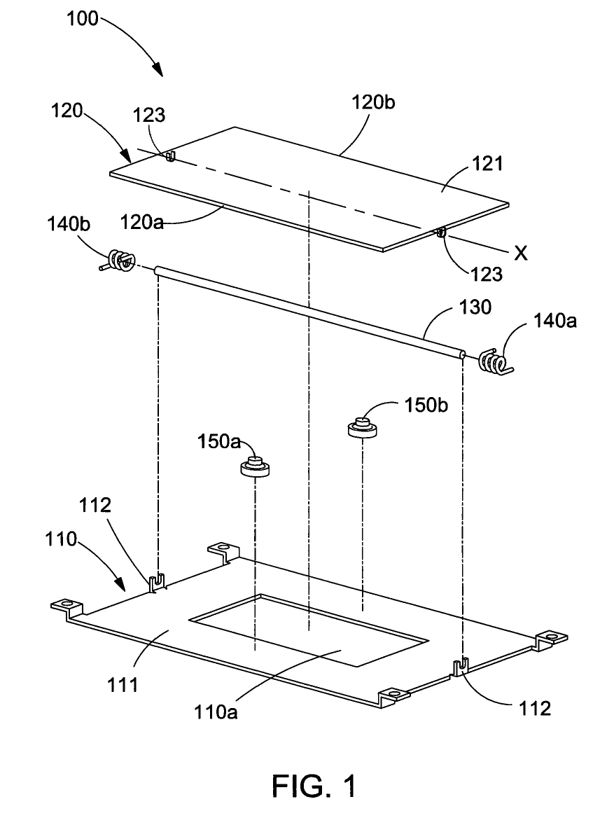

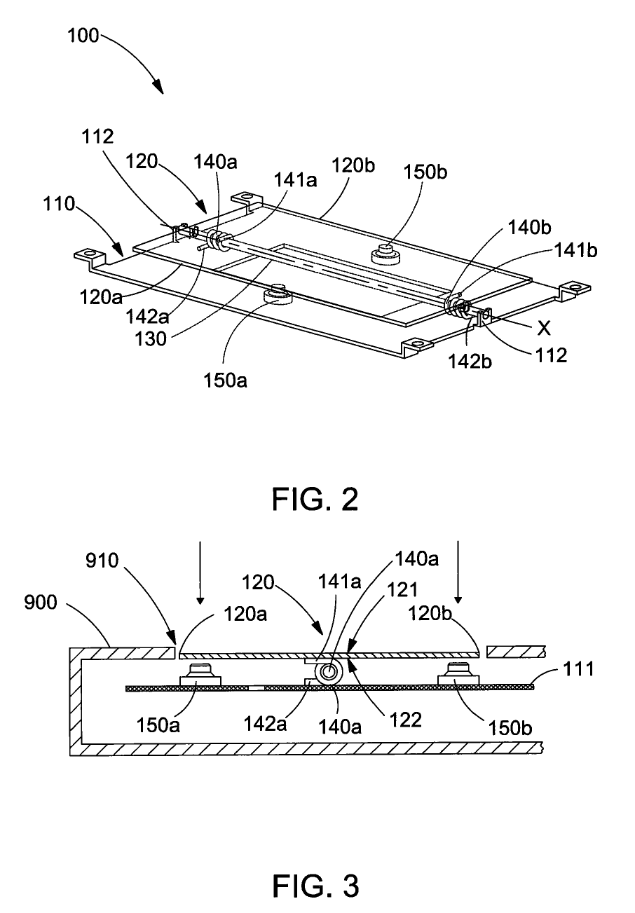

Referring to FIGS. 1 and 2, a modular touch control assembly 100 according to a first embodiment of the present invention is shown. The modular touch control assembly 100 is provided for generating a contact operating signal. The modular touch control assembly 100 is also provided for generating a press operating signal corresponding to an tilted direction The modular touch control assembly 100 includes a frame 110, a touchpad 120, a shaft 130, two elastic members 140a, 140b, and two switches 150a, 150b.

Referring to FIGS. 1 and 2, the frame 110 includes a substrate 111 and two pivot seats 112. The switches 150a, 150b are disposed on the substrate 111. The touchpad 120 is pivoted to the pivot seats 112, such that the touchpad 120 is pivotally disposed on the substrate 111 and is spaced from the substrate 111. The touchpad 120 is normally in parallel with the substrate 111. When the touchpad 120 is pressed, an included angle between the touchpad 120 and the substrate 111 is changed. Therefore, the touchpad 120 is tilted with respect to the substrate 111. The substrate 111 and the pivot seats 112 may be made of metal or plastic. The pivot seats 112 are monolithically formed with the substrate 111. In practical implementation, the substrate 110 includes one or a plurality of apertures 110a, in order to reduce materials required to form the substrate 111, and the pivot seats 112 are lugs extending at edges of the substrate 111.

Referring to FIGS. 1 to 3, the touchpad 120 includes a touch control surface 121 and a bottom surface 122. The touch control surface 121 is provided for being contacted to generate a contact operating signal. The bottom surface 122 faces the substrate 111. The touchpad 120 further includes two bumps 123 disposed on the bottom surface 122. The two bumps 123 are located at a rotation axis X. Two ends of the shaft 130 penetrate through the two bumps 123 along the rotation axis X respectively, such that the two ends of the shaft 130 are protruded from the two bumps 123 respectively. The two ends of the shaft 130 are also inserted in axle holes 112a of the pivot seats 112. Touchpad 120 is thus pivoted to the pivot seats 112 along the rotation axis X, so that the touchpad 120 is pivotally disposed on the substrate 111 and is spaced from the substrate 111. The touchpad 120 may be pressed to change an included angle between the touchpad 120 and the substrate 111.

Referring to again to FIGS. 1 and 2, the touchpad 120 includes a first side edge 120a and a second side edge 120b located at two sides of the rotation axis X. The touchpad 120 is tilted with respect to the substrate 111 of the frame 110 according to the rotation axis X after being pressed. Depending upon different pressed positions, the touchpad 120 may be tilted towards the first side edge 120a or the second side edge 120b.

Referring to FIGS. 1 to 3, each of the elastic members 140a, 140b in the first embodiment is a torsion spring, fitts over the shaft 130. The elastic members 140a, 140b are located between the bottom surface 122 of the touchpad 120 and the substrate 111 of the frame 110. Each of the torsion springs as the elastic members 140a, 140b includes first stressed end 141a, 141b and second stressed end 142a, 142b opposite to each other. The first stressed ends 141a, 141b are contacted with the bottom surface 122 of the touchpad 120. The second stressed ends 142a, 142b are contacted with the substrate 111 of the frame 110.

Furthermore, the first stressed end 141a and the second stressed end 142a of the elastic member 140a extend towards the first side edge 120a. The first stressed end 141b and the second stressed end 142b of the other elastic member 140b extend towards the second side edge 120b. When the touchpad 120 is not pressed to be tilted, the first stressed ends 141a, 141b of the two elastic members 140a, 140b are contacted with the bottom surface 122 of the touchpad 120, thereby maintaining the touchpad 120 at an original position. That is, the touchpad 120 is approximately in parallel with the substrate 111. At this time, the two elastic members 140a, 140b are not deformed.

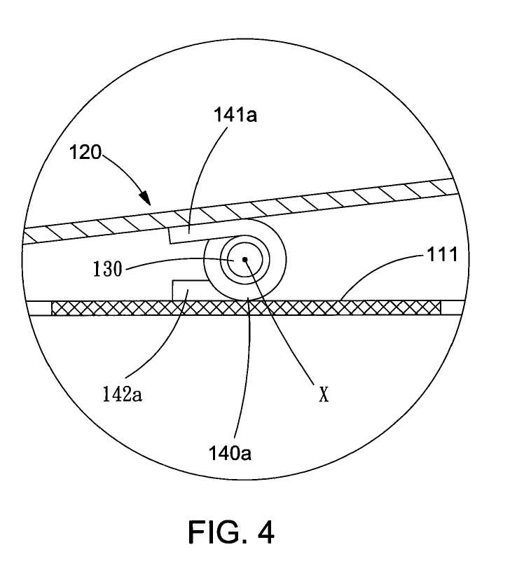

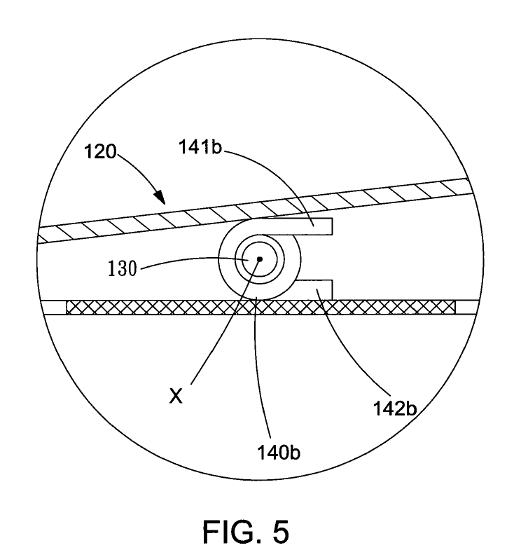

FIGS. 4 and 5 show relations among the substrate 111 of the frame 110, the touchpad 120, and the elastic members 140a, 140b. Other components are omitted in FIGS. 4 and 5. FIGS. 4 and 5 show statuses that the elastic members 140a, 140b are deformed when the touchpad 120 is tilted towards the first side edge 120a.

When the touchpad 120 is pressed and the pressed position thereof is between the rotation axis X and the first side edge 120a, the touchpad 120 is tilted towards the first side edge 120a. Meanwhile, the first stressed end 141a of the elastic member 140a is pressed downwards by the touchpad 120. The second stressed end 142a maintains in contact with the substrate 111 and becomes a fixed support point on the substrate 111, so that an angle between the first stressed end 141a and the second stressed end 142a of the elastic member 140a is reduced, such that the elastic member 140a is deformed to generate an elastic force to drive the touchpad 120 upwards. At the same time, the other elastic member 140b is not pressed and deformed. The bottom surface 121 of the touchpad 120 moves away from the first stressed end 141b of the other elastic member 140b and exerts no pressure on the elastic member 140b, such that an angle between the first stressed end 141b and the second stressed end 142b is not changed, and no elastic force is provided to the touchpad 120. When the pressure applied on the touchpad 120 is removed, the elastic member 140a drives the touchpad 120 upwards with the elastic force, as to reset the touchpad 120 to the original position. When the first stressed end 141a returns to a position before being pressed, the elastic force provided by the elastic member 140a disappears and no longer drives the touchpad 120. At this time, the first stressed ends 141a, 141b of the two elastic members 140a, 140b maintain in contact with the bottom surface 122 of the touchpad 120, such that the touchpad 120 is kept at the original position. On the contrary, when the touchpad 120 is pressed and the pressed position thereof is between the rotation axis X and the second side edge 120b, the touchpad 120 is tilted towards the second side edge 120b. At this time, the other elastic member 140b is pressed and deformed to generate an elastic force. Once the pressure applied on the touchpad 120 is removed, the elastic member 140b resets the touchpad 120 to the original position through the elastic force.

Referring to FIGS. 1 to 3, the elastic members 140a, 140b fit over the shaft 130. Instead of being fixed to the touchpad 120 and the substrate 111, the first stressed ends 141a, 141b and the second stressed ends 142a, 142b thereof are only contacted with the touchpad 120 and the substrate 111 respectively. Therefore, the assembling process of the elastic members 140a, 140b is relatively simple, thereby simplifying the complicated structure of the modular touch control assembly 100.

Referring to FIGS. 1 to 3, the switches 150a, 150b are disposed on the substrate 111 of the frame 110 and located at two sides of the rotation axis X respectively. The switches 150a, 150b serve as detectors to detect whether the touchpad 120 moves and is tilted with respect to the frame 110. Two switches 150a, 150b are also utilized to determine the tilting direction of the touchpad 120. One switch 150a corresponds to the first side edge 120a. The other switch 150b corresponds to the second side edge 120b. When the touchpad 120 moves and is tilted is tilted with respect to the substrate 111, one of the two switches 150a, 150b is triggered by the tilted touchpad 120 depending upon the tilting direction of the touchpad 120, thereby generating a corresponding press operating signal.

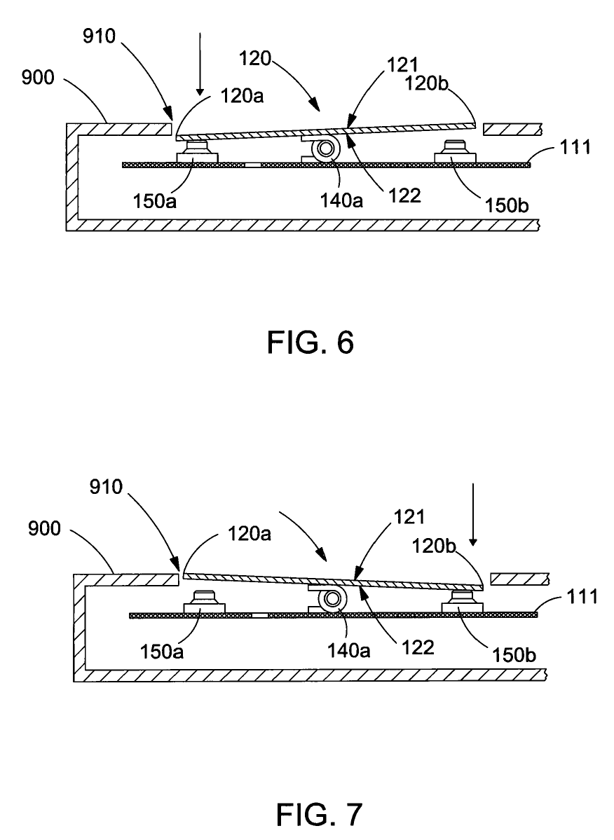

Referring to FIGS. 6 and 7, according to the aforementioned structure of the modular touch control assembly 100, a user can touch the touch control surface 121 of the touchpad 120 with fingers. The touchpad 120 generates a motion track or a click according to a motion of a contact point on the touch control surface 121 and changes of touching times on the touch control surface 121. In addition, the user can press down the touchpad 120 directly, such that the touchpad 120 is tilted. The tilted touchpad 120 triggers one of the two switches 150a, 150b with the bottom surface 122 thereof.

As shown in FIG. 6, when the pressed position that the touchpad 120 is pressed is between the rotation axis X and the first side edge 120a, the touchpad 120 is tilted towards the first side edge 120a, such that the switch 150a shown on the left in FIG. 6 is triggered and then the switch 150a generates a corresponding press operating signal to scroll down the displayed data in the window.

As shown in FIG. 7, when the pressed position that the touchpad 120 is pressed is between the rotation axis X and the second side edge 120b, the touchpad 120 is tilted towards the second side edge 120b, such that the switch 150b shown on the right in FIG. 7 is triggered and then the switch 150b generates a corresponding press operating signal to scroll up the displayed data in the window.

The first side edge 120a and the second side edge 120b may be arranged corresponding to operations of scrolling left or right the displayed data in the window respectively, that is, the first side edge 120a and the second side edge 120b may be configured at left and right sides of the touchpad 120. When the touchpad 120 is tilted towards the first side edge 120a, and the switch 150a shown on the left in FIG. 6 is triggered, the switch 150a generates a press operating signal to scroll leftwards the displayed data in the window. When the touchpad 120 is tilted towards the second side edge 120b, and the switch 150b shown on the right in FIG. 7 is triggered, the switch 150b generates a press operating signal to scroll rightwards the displayed data in the window.

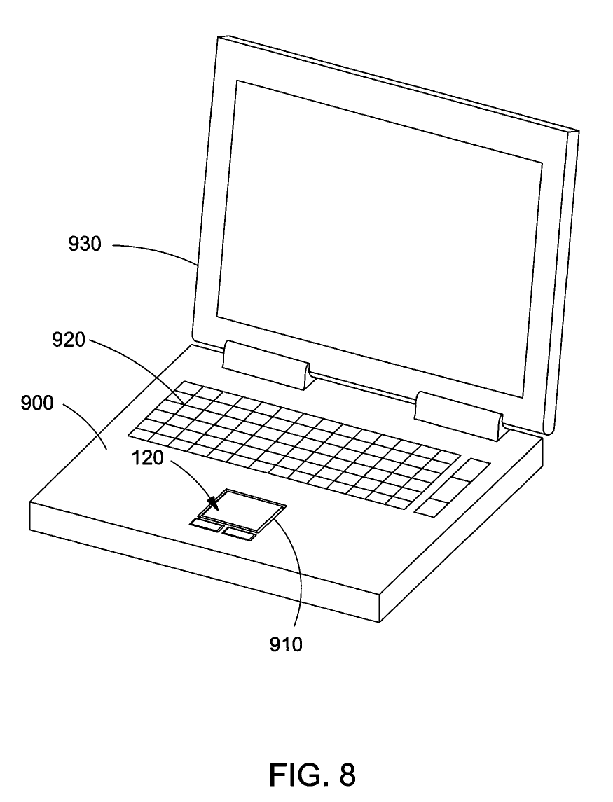

Referring to FIGS. 3, 6, 7, and 8, the first embodiment of the present invention further provides an electronic device having the modular touch control assembly 100. The electronic device may be a part of a computer, for example, a laptop computer. The electronic device may also be a wired or wireless peripheral device connected to the computer. The electronic device includes a body 900, a modular touch control assembly 100, and a keyboard 920. The body 900 includes an opening 910 on its surface. The modular touch control assembly 100 is disposed in the body 900. The substrate 110 is fixed in the body 900. The touchpad 120 is pivotally disposed on the substrate 110 and located at the opening 910, such that the touch control surface 121 is exposed through the opening 910 for being operated by the user. The keyboard 920 is disposed on the surface of the body 900 for the user to input dada or commands. When the electronic device is a laptop computer, the electronic device further includes a display screen 930 pivoted to one side edge of the body 900 for displaying information.

In practical application, the user may operate the touchpad 120 directly, such that the touchpad 120 generates contact operating signals to move a cursor displayed on the display screen 930 and uses the keyboard 920 to input data and commands. When the user intends to scroll the window, the user simply presses the touchpad 120 to make the touchpad 120 be tilted to press the switch 150a, or 150b. Specifically, when the user intends to scroll up the window, the user presses the touchpad 120 at a position between the first side edge 120a and the rotation axis X, then the touchpad 120 is tilted to trigger the switch 150a, and the switch 150a generates a corresponding press operating signal. After receiving the press operating signal, the computer scrolls up displayed data in the window according to the press operating signal. When the user intends to scroll down the window, the user may press the touchpad 120 at a position between the second side edge 120b and the rotation axis X, then the touchpad 120 is tilted to triggered the other switch 150b, and the switch 150b generates a corresponding press operating signal. After receiving the press operating signal, the computer scrolls down displayed data in the window according to the press operating signal. As discussed above, the rotation axis X, the first side edge 120a, and the second side edge 120b may also be rotated for 90 degrees, and the positions of the switches 150a, 150b are changed accordingly, thereby realizing the operations of scrolling displayed data the window left or right.

In the modular touch control assembly 100 according to the first embodiment of the present invention, all components are integrated into a single module. Therefore, the modular touch control assembly 100 directly replaces a conventional touchpad, and is disposed corresponding to the opening 910 of the body 900. A structure of the single module facilitates the direct replacement of the conventional touchpad and simplifies the assembling process of the electronic device.

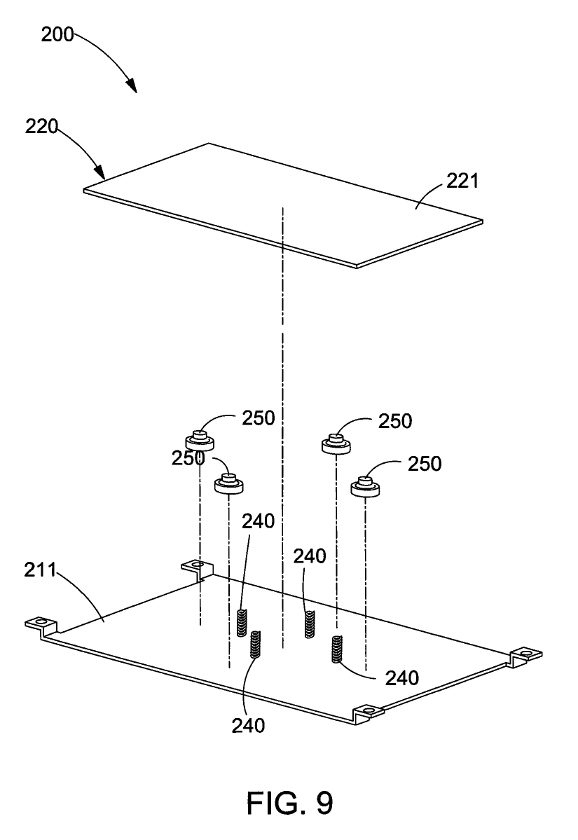

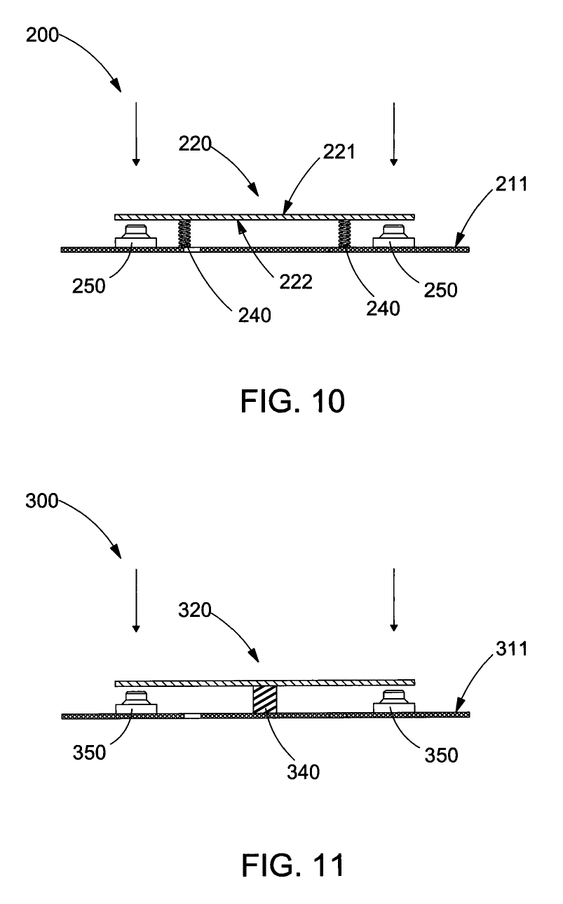

FIGS. 9 and 10 show a modular touch control assembly 200 according to a second embodiment of the present invention. The modular touch control assembly 200 is disposed in an electronic device. The modular touch control assembly 200 includes a substrate 211, a touchpad 220, a plurality of elastic members 240, and a plurality of switches 250. The modular touch control assembly 200 in the second embodiment provides more than two rotation axial directions, and increases directions of the touchpad 220 to be tilted to increase types of press operating signals. In addition, a difference between the second embodiment and the first embodiment is that, the modular touch control assembly 200 in the second embodiment is equipped without a shaft. The omission of the shaft further simplifies the assembly of the modular touch control assembly 200 and the inclining directions of the touchpad 220 are not limited by the shaft.

Referring to FIGS. 9 and 10, the switches 250 are disposed on the substrate 211. The touchpad 220 is connected to the substrate 211 through the elastic members 240, such that the touchpad 220 is movably disposed above the substrate 211 and is spaced from the substrate 211. When the touchpad 220 is pressed and is tilted, an included angle between the touchpad 220 and the substrate 211 is changed according to a pressed position on the touchpad 220. The touchpad 220 includes a touch control surface 221 and a bottom surface 222. The touch control surface 221 is provided for being contacted to generate a contact operating signal. The bottom surface 222 faces the substrate 211.

Referring to FIGS. 9 and 10, the elastic members 240 in the second embodiment are springs. Two ends of each elastic member 240 are connected to the bottom surface 222 of the touchpad 220 and the substrate 211 respectively, such that the touchpad 220 is movably disposed above the substrate 211.

When the touchpad 220 is tilted after being pressed, some of the elastic members 240 are compressed and the other elastic members 240 are stretched, the elastic members 240 generate elastic force to reset the touchpad 220 to an original position. When a pressure applied on the touchpad 220 is removed, the elastic members 240 reset the touchpad 220 to the original position through the elastic force. When the touchpad 220 is reset to the original position, that is each elastic member 240 is neither suppressed nor stretched, the elastic force disappears and the elastic members 240 no longer drive the touchpad 220. In order to avoid the circumstance that the touchpad 220 is tilted significantly due to the contact on the touch control surface 221 of the touchpad 220 to mis-trigger the press operating signals continuously when the touch control function provided by the touch control surface 221 is used, elastic coefficients of all the elastic members 240 are set to be higher than a constant value. Thus, when the user touches the touch control surface 221 with a relative small pressure to use the touch control function, the elastic members 240 having sufficient high elastic coefficients are not deformed, or the deformed slightly that the deformation can be neglected at this time. When the user actually presses down the touchpad 220, the pressing force exerted is sufficient for deforming the elastic members 240 and tilting the touchpad 220.

Compared with the first embodiment, the touchpad 220 in the second embodiment is connected to the substrate 211 through the elastic members 240. Thus, the directions that the touchpad 220 being tilted are not limited by the shaft or the rotation axis, and the touchpad 220 may be tilted in any direction. The touchpad 220 may be used for triggering more than two switches 250 to increase types of press operating signals that may be generated, thereby converting the press operating signals into direction signals in various directions, in order to provide operation functions in various axial directions.

FIG. 11 shows a modular touch control assembly 300 in a third embodiment of the present invention. The modular touch control assembly 300 is disposed in an electronic device, and the modular touch control assembly 300 includes a substrate 311, a touchpad 320, an elastic member 340, and a plurality of switches 350.

The modular touch control assembly 300 in the third embodiment includes only one elastic member 340. The elastic member 340 may be an elastic rubber column or spring having a high rigidity (the elastic coefficient thereof is higher than a constant value), which is used for connecting the touchpad 320 to the substrate 311. Thus, the touchpad 320 is movably disposed above the substrate 311 through the elastic member 340 and is spaced from the substrate 311. The touchpad 320 may be tilted after being pressed, such that an included angle between the touchpad 320 and the substrate 311 is changed. When the touchpad 320 is tilted after being pressed, the elastic member 340 is bent and is deformed to generate elastic force. When the pressure applied on the touchpad 320 is removed, the elastic member 340 resets the touchpad 320 to an original position through the elastic force. When the touchpad 320 is reset to the original position, that is when the elastic member 340 is no longer compressed or stretched, the elastic force disappears and the elastic member 340 no longer drives the touchpad 320.

Compared with the first embodiment, the modular touch control assembly 300 in the third embodiment is equipped without a shaft, such that the inclining directions of the touchpad 320 are not limited by the shaft. Compared with the second embodiment, the third embodiment further simplifies a plurality of elastic members into a single elastic member 340, in order to further simplify the assembly of the modular touch control assembly 300.

When the touchpad in each embodiment is tilted upon being pressed, not only the press operating signals are triggered, but also the touch control surface of the touchpad may be touched to generate a contact operating signal. The press operating signal and the contact operating signal are generated at the same time and may cause errors in operation. Specifically, when the user needs to trigger a press operating signal, the user is not willing to generate a contact operating signal.

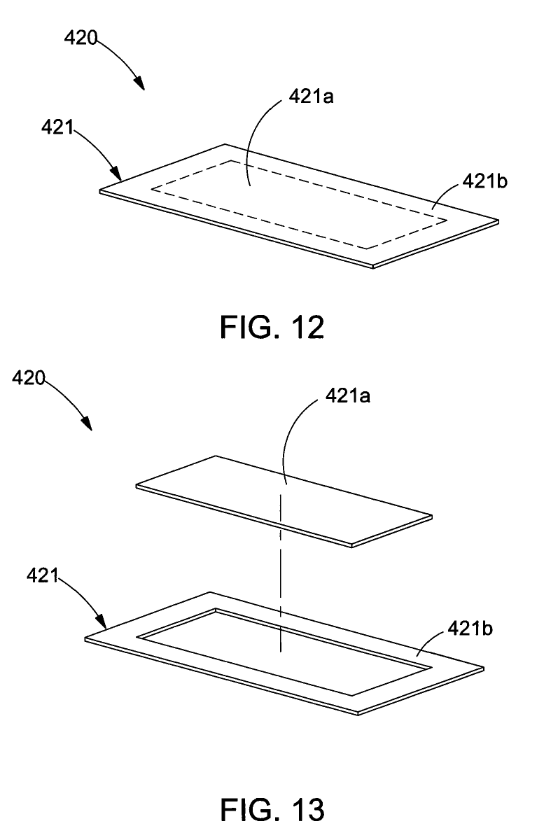

FIGS. 12 and 13 show a touchpad 420 according to a fourth embodiment of the present invention. The touchpad 420 is applied in a modular touch control assembly of the present invention. The touchpad 420 includes a touch control surface 421 and a bottom surface (not shown in the figures).

The touch control surface 421 includes a touch control area 421a and a pressed area 421b surrounding the touch control area 421a. The touch control area 421a is provided for being contacted to generate a contact operating signal. The pressed area 421b is equipped without touch control function and is located at the edges of the touch control surface 421. The touch control area 421a and the pressed area 421b may be a surface of a single touch component, and the touch control function of the pressed area 421b is disabled through configurations of drivers or control circuits, as shown in FIG. 12. That is, the touch control surface 421 includes an area where the touch control function is enabled to serve as the touch control area 421a and an area where the touch control function is disabled to serve as the pressed area 421b. In addition, the pressed area 421b may also be a thin plate having a hollow area and equipped without a touch control function, which is further joined at the edges of the touch control area 421a, as shown in FIG. 13.

The touchpad 420 in the fourth embodiment may be applied in the modular touch control assemblies in other embodiments of the present invention. In practical application, the user may directly operate the touch control area 421a, such that the touchpad 420 generates a contact operating signal. When the user intends to generate a press operating signal, the user may touch the pressed area 421b and press the touchpad 420, such that the touchpad 420 is tilted to generate a press operating signal. As the pressed area 421b is equipped without the touch control function, no contact operating signal is generated when the user touches the pressed area 421b, thereby preventing the contact operating signal and the press operating signal from being generated at the same time.

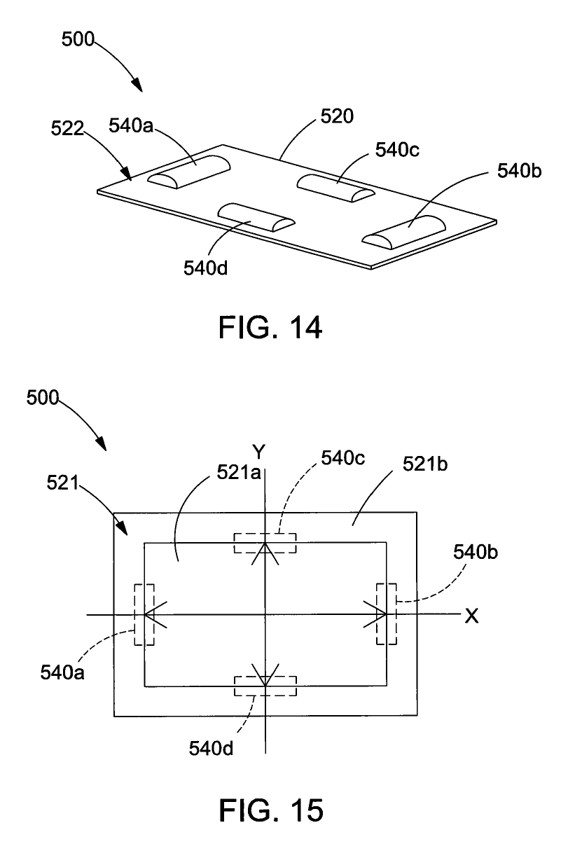

FIGS. 14 and 15 show a modular touch control assembly 500 according to a fifth embodiment of the present invention, which is disposed in an electronic device. The modular touch control assembly 500 includes a substrate (not shown in the figures), a touchpad 520, a plurality of elastic members 540a, 540b, 540c, 540d, and a plurality of switches (not shown in the figures). The touchpad 520 includes a touch control surface 521 and a bottom surface 522. The touch control surface 521 includes a touch control area 521a and a pressed area 521b surrounding the touch control area 521a. The touch control area 521a is provided for being contacted to generate a contact operating signal. The pressed area 521b is equipped without touch control function. The touch control area 521a and the pressed area 521b may be a surface of a single touch component, and the surface is defined as the touch control area 521a and the pressed area 521b through configurations of drivers or control circuits.

The details of the substrate and the switches are the same as that mentioned in the first, the second, the third, or the fourth embodiment. The touchpad 520 is disposed above the substrate. The bottom surface 522 faces the substrate. The elastic members 540a, 540b, 540c, 540d are disposed on the bottom surface 522 of the touchpad, such that the touchpad 520 is disposed above the substrate and is spaced from the substrate. The touchpad 520 may be tilted relative to the substrate upon being pressed, such that a corresponding switch is triggered to generate a corresponding press operating signal. The elastic members 540a, 540b, 540c, 540d are elastic blocks disposed in pairs. A rotation axis X or Y runs through each pair of the elastic blocks, and each of the elastic blocks is disposed corresponding to a boundary between the touch control area 521a and the pressed area 521b. Taking the rotation axis X as an example, the rotation axis X runs through the elastic members 540a and 540b, such that after being pressed, the touchpad 520 is swiveled and tilted about the rotation axis X. The elastic members 540c and 540d are deformed when the touchpad 520 is tilted, to generate an elastic force for resetting the touchpad 520 to an original position. When the user operates the touch control area 521a, the elastic members 540a, 540b, 540c, 540d are not pressed directly. If elastic coefficients of the elastic blocks are higher than a constant value, the elastic members 540a, 540b, 540c, 540d are only slightly deformed or even not deformed when the user operates the touch control area 521a, thereby avoiding the circumstances that the touchpad 520 is tilted when the user operates the touch control area 521a and unexpected press operating signals are generated.

When the user presses the pressed area 521b, for example, at a position close to the elastic member 540b in FIG. 15, the elastic member 540b is directly compressed and deformed, such that the touchpad 520 is tilted at the press position to generate a descending motion similar to that of a push button when being pressed. Correspondingly, the elastic member 540b provides a feedback force. Therefore, during practical operations for generating a press operating signal, the user must exert a pressure directly on corresponding elastic members 540a, 540b, 540c, and 540d at the rotation axis X, Y, in order to enable the touchpad 520 to be tilted. Considering the typical regular behavior of a common user, when the user needs to perform press motions for scrolling up, down, left, and right the window, the user presses edges of the touchpad 520 along the rotation axes X and Y instinctively. Therefore, this embodiment further conforms to visual and typical regular behaviors of the user.

For another application example of the modular touch control assembly 500 in the fifth embodiment, the pressed area 521b is provided for being pressed to generate press operating signals, and the pressed area 521b is further divided into a plurality of sections. Each section is used for being pressed to generate a different press operating signal. In such a manner, the switches may be further omitted, in order to simplify the parts of the modular touch control assembly 500, such that the manufacturing and assembling processes of the modular touch control assembly 500 become more convenient.

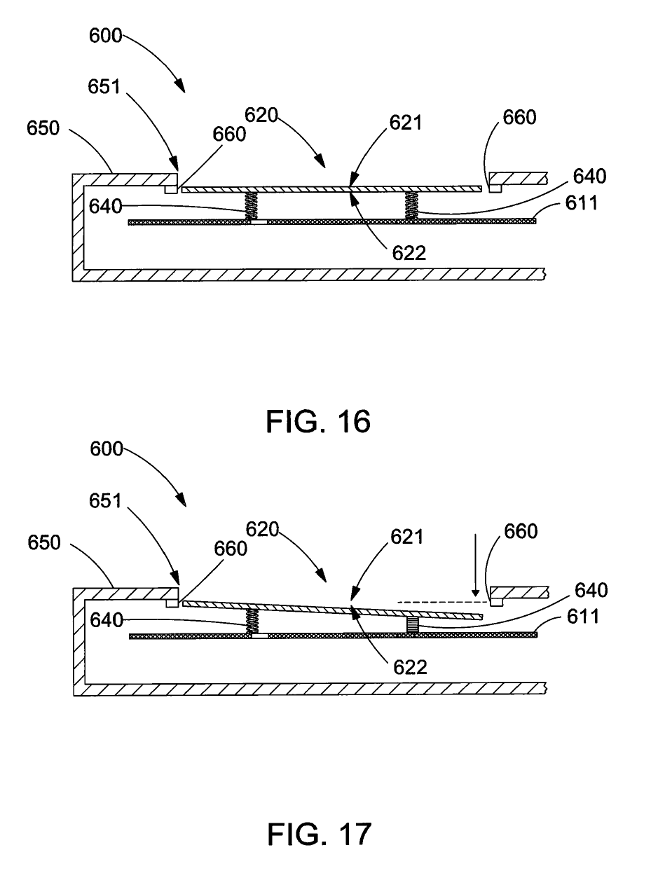

FIG. 16 shows an electronic device 600 according to a sixth embodiment of the present invention. The electronic device 600 includes a body 650, a substrate 611, a touchpad 620, one or plurality of elastic members 640, and a plurality of displacement detectors 660. The touchpad 620 may be the touchpad 120, 220, 320, or 420 in the first to fourth embodiments.

Referring to FIG. 16, the body 650 includes an opening 651. The substrate 611 is disposed in the body 650. The touchpad 620 includes a touch control surface 621 and a bottom surface 622. The touch control surface 621 is provided for being touched to generate a contact operating signal. The bottom surface 622 of the touchpad 620 faces the substrate 611, such that the touch control surface 621 is disposed above the substrate 611 and is spaced from the substrate 611. After being pressed, the touchpad 620 is tilted, and an included angle is formed between the touchpad 620 and the substrate 611. The elastic member 640 is disposed between the substrate 611 and the bottom surface 622 of the touchpad 620. When the touchpad 620 is tilted, the elastic member 640 is deformed to generate an elastic force for resetting the touchpad 620 to an original position.

The displacement detectors 660 are disposed in the body 650 and located at an edge of the opening 651. A horizontal height at which the displacement detector 660 is disposed corresponding to a height of the edge of the touchpad 620 when the touchpad 620 is at a original position, thereby detecting whether displacement occurs to the edge of the touchpad 620 or not. Each of the displacement detectors 660 may be a Hall effect sensor, an electronic-eye sensor, or or an electrical contact maintaining an electrical connection with the touchpad 620.

As shown in FIG. 17, when the touchpad 620 is tilted upon being pressed, one side edge close to the press position displaces downwards, such that the displacement detector 660 detects that displacement occurs to the edge of the touchpad 620. In this way, a tilting direction of the touchpad 620 is determined, thereby generating a corresponding press operating signal.

In the sixth embodiment, the tilt detection of the touchpad 620 is further simplified. The displacement detectors 660 used for tilt detection are disposed at an inner side of the body 650 of the electronic device 600, instead of being disposed between the touchpad 620 and the substrate 611. Therefore, a distance between the touchpad 620 and the substrate 611 is further decreased, without being limited by sizes of switches or displacement detectors 660.

While the present invention includes been described by the way of example and in terms of the preferred embodiments, it is to be understood that the invention is not limited to the disclosed embodiments. To the contrary, it is intended to cover various modifications and similar arrangements. Therefore, the scope of the appended claims should be accorded the broadest interpretation in order to encompass all such modifications and similar arrangements.

What is claimed is:

1. A modular touch control assembly, for generating a contact operating signal and at least two press operating signals, comprising:
a substrate;
a touchpad, pivotally disposed on the substrate, to be pressed at a original position and then being tilted according to a rotation axis, so as to change the comprised angle between the touchpad and the substrate; the touchpad comprising a touch control surface to be contacted to generate the contact operating signal and a bottom surface facing the substrate;
at least one elastic member, disposed between the bottom surface of the touchpad and the substrate, for being deformed by the touchpad after the touchpad is tilted, to generate an elastic force to reset the touchpad to the original position; and
two switches, disposed on the substrate, and located at two sides of an rotation axis; each of the switches for being pressed by the touchpad after the touchpad is tilted, to generate one of the two press operating signals.

2. The modular touch control assembly as claimed in claim 1, further comprising:
two pivot seats, disposed on the substrate;
two bumps, disposed on the bottom surface of the touchpad; and
a shaft, penetrating through the two pivot seats and the bumps to pivotally dispose the touchpad on the substrate.

3. The modular touch control assembly as claimed in claim 2, wherein the elastic member is a torsion spring, fitting over the shaft.

4. The modular touch control assembly as claimed in claim 3, wherein the modular touch control assembly comprising two elastic members, and each of the elastic members comprises a first stressed end and a second stressed end contacting with the bottom surface of the touchpad and the substrate respectively; the first stressed end and the second stressed end of one of the elastic members extend towards one side edge of the touchpad; and the first stressed end and the second stressed end of the other elastic member extend towards the other side edge of the touchpad.

5. The modular touch control assembly as claimed in claim 1, wherein the touch control surface comprises:
a touch control area, for being contacted to generate the contact operating signal; and
a pressed area, surrounding the touch control area and equipped without touch control function.

6. An electronic device having a modular touch control assembly, comprising:
a body, having an opening;
a substrate, disposed in the body;
a touchpad, pivotally disposed on the substrate and located at the opening, to be pressed at an original position and then being tilted according to a rotation axis, so as to change the comprises angle between the touchpad and the substrate; the touchpad comprising a touch control surface to be contacted to generate the contact operating signal and a bottom surface facing the substrate;
at least one elastic member, disposed between the bottom surface of the touchpad and the substrate, for being deformed by the touchpad after the touchpad is tilted, to generate an elastic force to reset the touchpad to the original position; and
two switches, disposed on the substrate and located at two sides of an rotation axis; each of the switches for being pressed by the touchpad after the touchpad is tilted, to generate one of the two press operating signals.

7. The electronic device as claimed in claim 6, further comprising:
two pivot seats, disposed on the substrate;
two bumps, disposed on the bottom surface of the touchpad; and
a shaft, penetrating through the two pivot seats and the bumps to pivotally dispose the touchpad on the substrate.

8. The electronic device as claimed in claim 7, wherein the elastic member is a torsion spring, fitting over the shaft.

9. The electronic device as claimed in claim 8, wherein the modular touch control assembly comprising two elastic members, and each of the elastic members comprises a first stressed end and a second stressed end contacting with the bottom surface of the touchpad and the substrate respectively; the first stressed end and the second stressed end of one of the elastic members extend towards one side edge of the touchpad; and the first stressed end and the second stressed end of the other elastic member extend towards the other side edge of the touchpad.

10. The electronic device as claimed in claim 6, wherein the touch control surface comprises:
a touch control area, for being contacted to generate the contact operating signal; and
a pressed area, surrounding the touch control area and equipped without touch control function.

11. A modular touch control assembly, for generating a contact operating signal and a plurality of press operating signals, comprising:
a substrate;
a touchpad, disposed above the substrate and spaced from the substrate, to be pressed at an original position and then being tilted; the touchpad comprising a touch control surface to be contacted to generate the contact operating signal and a bottom surface facing the substrate;
at least one elastic member, disposed between the bottom surface of the touchpad and the substrate, for being deformed by the touchpad after the touchpad is tilted, to generate an elastic force to reset the touchpad to the original position; and
a plurality of switches, disposed on the substrate; each of the switches for being pressed by the touchpad after the touchpad is tilted, to generate one of the press operating signals.

12. The modular touch control assembly as claimed in claim 11, wherein the elastic member is a spring or an elastic rubber column, and two ends of the elastic member are connected to the bottom surface of the touchpad and the substrate respectively.

13. The modular touch control assembly as claimed in claim 11, wherein the touch control surface comprises:
a touch control area, for being contacted to generate the contact operating signal; and
a pressed area, surrounding the touch control area and equipped without touch control function.

14. An electronic device having a modular touch control assembly, comprising:
a body, having an opening;
a substrate, disposed in the body;
a touchpad, disposed above the substrate and spaced from the substrate, to be pressed at an original position and then being tilted; the touchpad comprising a touch control surface to be contacted to generate the contact operating signal and a bottom surface facing the substrate;
at least one elastic member, for generating an elastic force to reset the touchpad to the original position when the touchpad is tilted; and
a plurality of switches, disposed on the substrate; each of the switches for being pressed by the touchpad after the touchpad is tilted, to generate one of the press operating signals.

15. The electronic device as claimed in claim 14, wherein the elastic member is a spring or an elastic rubber column, and two ends of the elastic member are connected to the bottom surface of the touchpad and the substrate respectively.

16. The electronic device as claimed in claim 14, wherein the touch control surface comprises:
a touch control area, for being contacted to generate the contact operating signal; and
a pressed area, surrounding the touch control area and equipped without touch control function.

17. A modular touch control assembly, for generating a contact operating signal and a plurality of press operating signals, comprising:
a substrate;
a touchpad, disposed above the substrate and spaced from the substrate, and the touchpad comprising:
a touch control surface, comprising a touch control area and a pressed area surrounding the touch control area, wherein the touch control area is provided for being contacted to generate the contact operating signal, and the pressed area is equipped without touch control function; and
a bottom surface, facing the substrate;
a plurality of elastic blocks, disposed on the bottom surface of the touchpad in pairs, wherein a rotation axis runs through each pair of the elastic blocks, each of the elastic blocks is disposed corresponding to a boundary between the touch control area and the pressed area, and each of the elastic blocks is deformed by the touchpad after the touchpad is tilted to generate an elastic force for resetting the touchpad; and
a plurality of switches, disposed on the substrate; each of the switches for being pressed by the touchpad after the touchpad is tilted, so to generate one of the press operating signals.

18. An electronic device having a modular touch control assembly, comprising:
a body, having an opening;
a substrate, disposed in the body;
a touchpad, disposed above the substrate and spaced from the substrate, and the touchpad comprising:
a touch control surface, comprising a touch control area and a pressed area surrounding the touch control area, wherein the touch control area is provided for being contacted to generate the contact operating signal, and the pressed area is equipped without touch control function; and
a bottom surface, facing the substrate;
a plurality of elastic blocks, disposed on the bottom surface of the touchpad in pairs, wherein a rotation axis runs through each pair of the elastic blocks, each of the elastic blocks is disposed corresponding to a boundary between the touch control area and the pressed area, and each of the elastic blocks is deformed by the touchpad after the touchpad is tilted to generate an elastic force for resetting the touchpad; and
a plurality of switches, disposed on the substrate; each of the switches for being pressed by the touchpad after the touchpad is tilted, to generate one of the press operating signals.

19. A modular touch control assembly, for generating a contact operating signal and a plurality of press operating signals, comprising:
a touchpad, comprising:
a touch control surface, comprising a touch control area and a pressed area surrounding the touch control area, wherein the touch control area is provided for being contacted to generate the contact operating signal, the pressed area is divided into a plurality of sections, and each of the sections is provides for being pressed to generate one of the press operating signals; and
a bottom surface; and
a plurality of elastic members, disposed on the bottom surface of the touchpad, at least one of the elastic members is selectively deformed by the touchpad after the touchpad is pressed to be tilted, so the deformed one of the elastic members generate an elastic force for restoring the touchpad.

20. The modular touch control assembly as claimed in claim 19, wherein each of the elastic members is disposed corresponding to a boundary between the touch control area and the pressed area, and the elastic members are arranged in pairs.

21. An electronic device having a modular touch control assembly, for generating a contact operating signal and a plurality of press operating signals, the electronic device comprising:
a body, having an opening;
a substrate, disposed in the body;
a touchpad, disposed above the substrate and spaced from the substrate, and the touchpad for being pressed to be tilted at an original position; the touchpad comprising a touch control surface for being contacted to generate the contact operating signal and a bottom surface facing the substrate;
at least one elastic member, disposed between the substrate and the bottom surface of the touchpad, for being deformed by the touchpad after the touchpad is tilted, so as to generate an elastic force for resetting the touchpad to the original position; and
a plurality of displacement detectors, disposed in the body, located at the edges of the opening, for the detection of whether displacement occurs at the edges of the touchpad or not, and generating one of the corresponding press operating signals when the displacement occurs at the edges of the touchpad.

22. The electronic device as claimed in claim 21, wherein each of the displacement detectors is a Hall effect sensor, an electronic-eye sensor, or an electrical contact maintaining an electrical connection with the touchpad.

23. The electronic device as claimed in claim 21, wherein the touch control surface comprises:
a touch control area, for being contacted to generate the contact operating signal; and
a pressed area, surrounding the touch control area and equipped without touch control function.
